(19) United States
(12) Patent Application Publication
(10) Pub. No.: US 2014/0317713 A1
(43) Pub. Date: Oct. 23, 2014

(54) Method and System of User Authentication Using an Out-of-band Channel

(71) Applicant: MPayMe Ltd., Hong Kong (HK)

(72) Inventor: Alessandro GADOTTI, Hong Kong (HK)

(21) Appl. No.: 14/321,830

(22) Filed: Jul. 2, 2014

Related U.S. Application Data
(63) Continuation-in-part of application No. 13/602,197, filed on Sep. 2, 2012.
(60) Provisional application No. 61/842,386, filed on Jul. 3, 2013.

(51) Int. Cl. H04L 29/06

(52) U.S. Cl. CPC H04L 63/0853
USPC 726/7

(57) ABSTRACT

The user authentication method comprises: a central processing server generates an encoded data, such as a QR code, from encoding a session number, which can be randomly generated; a first client computing device displays a login page that includes the QR code to a user for authentication; the user uses a mobile communication that has already been registered and paired with the user account stored in the central processing server to image-capture the QR code, and sends the decoded QR code data to the central processing server; the central processing server validates the decoded QR code data against the session number; upon a positive validation, the user may need to enter his/her security PIN according to configuration in the second mobile communication and be sent to the central processing server for validation; and upon a positive validation, the user authentication is completed.

### CLAIM FOR DOMESTIC PRIORITY

This application claims priority under 35 U.S.C. §119 to the U.S. Provisional Patent Application No. 61/842,386, filed Jul. 3, 2013, the disclosure of which is incorporated herein by reference in its entirety.

### CROSS-REFERENCE TO RELATED APPLICATIONS

This application is a continuation-in-part application of the U.S. patent application Ser. No. 13/602,197 filed Sep. 2, 2012, the disclosure of which is incorporated herein by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to methods and systems of online user authentication. Particularly, the present invention relates to online user authentication techniques that utilize out-of-band channels.

### BACKGROUND

Many online activities, such as making online purchases and payments, which involve accessing personal and protected information often require user authentication. The most common form of user authentication is the use of a login challenge for a user identifier and password. However, there are a number of drawbacks in this form of user authentication, which include forgotten password, stolen user identifier and/or password, and too simple password, resulting in weak security. Other multi-factor and strong authentication methods and systems have been developed; but most could not uphold strong security without sacrificing user convenience. Therefore, there is a need for a user authentication method and system that can support strong security and yet demand minimal efforts on the part of the users.

### SUMMARY

It is an objective of the present invention to provide a method and system for online user authentication using a mobile communication device. Since the mobile communication device is pre-registered in the user authentication authority system and that the mobile communication device can uniquely identify the authenticating user, it serves as the out-of-band channel for authenticating the user. It is a further objective of the present invention to provide such a method and system that support strong security and require the user to memorize and supply only a security personal identification number for authentication.

In accordance with various embodiments, the present invention can be implemented as an extension to the secure mobile payment system described in U.S. patent application Ser. No. 13/602,197.

In accordance with various embodiments, the present invention comprises a central processing server accessible through a communication network, such as the Internet; a plurality of users; mobile communication devices and client computing devices that can access the central processing server; and a third party computing processor that can access the central processing server.

In accordance with various embodiments, the functionalities of the central processing server comprises user authentication, user account management for managing user accounts, wherein the user accounts contain user identification and authentication credentials, and are stored securely in a database.

In accordance with various embodiments, the central processing server includes a plurality of user interfaces for user interaction using various types of computing devices and mobile communication devices running web browser applications. In addition, the central processing server also includes server backend APIs for machine-to-machine integration enabling specially-developed applications running in the third party computing processor to communicate with the central processing server. These user interfaces and server backend APIs facilitate the functionalities including, but are not limited to, user authentication, user account management and online shopping by users, system administration by administrators, online shopping inventory, payment, and fulfillment management by users.

In accordance with various embodiments, each of the mobile communication devices is equipped with a camera or scanner for optically capturing images of computer-generated encoded data such as barcodes. In accordance with various embodiments, the mobile communication device is configured to process the captured encoded data image and exchange data with the central processing server for facilitating various aforementioned functionalities such as user authentication.

The central processing server with its database, user interfaces and server backend APIs, and the mobile communication devices running the secure mobile transaction mobile application constitute a secure mobile transaction system. In accordance with various embodiments, each user account in the secure mobile transaction system may associate (pair) with only a single mobile communication device at any one time.

In one aspect of the present invention, a user who has already been registered and created a valid user account in the secure mobile transaction system may use his/her mobile communication device that has already been registered and paired in the secure mobile transaction system to authenticate for accessing a protected third party application, such as a third party web site, provided by the third party processing server, or one or more protected user interfaces provided by the central processing server. The user authentication method comprises: the central processing server generates an encoded data, such as a QR code, from encoding a session number, which can be randomly generated; a first mobile communication device or a first client computing device displays a login page that includes the QR code to the user for authentication; the user uses a second mobile communication that has already been registered and paired in the secure mobile transaction system to image-capture the QR code, and sends the decoded QR code data to the central processing server; the central processing server validates the decoded QR code data against the session number; upon a positive validation, the user enters his/her security PIN in the second mobile communication and be sent to the central processing server for validation; and upon a positive validation, the user authentication is completed.

### BRIEF DESCRIPTION OF THE DRAWINGS

Embodiments of the invention are described in more detail hereinafter with reference to the drawings, in which

FIG. 1 shows a block diagram illustrating an embodiment of the presently claimed secure mobile transaction system; and

FIG. 2 depicts a user activity diagram illustrating an embodiment of user authentication process using the secure mobile transaction system; and

FIG. 3 shows an exemplary embodiment of the transitioning user interface being displayed during the user authentication process using the secure mobile transaction system.

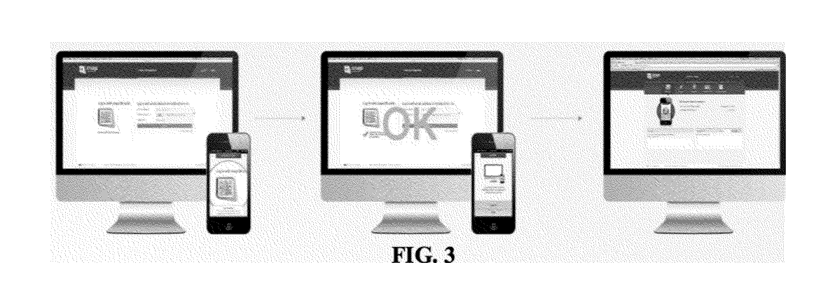

### DETAILED DESCRIPTION

In the following description, methods and systems of online user authentication using out-of-band channels and the like are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

### System

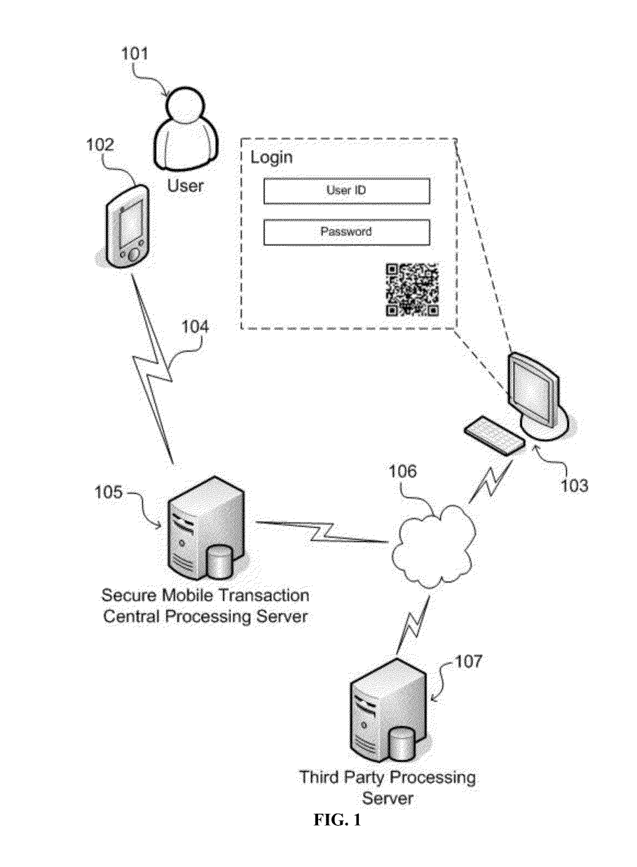

Referring to FIG. 1. In accordance with various embodiments the presently claimed invention comprises a central processing server 105 accessible through a first communication network 104, which can be the Internet, a telecommunication network, or any network supporting the TCP/IP protocol; a plurality of users 101 each associating with a user account; mobile communication devices 102 that can access the central processing server 105 through the first communication network 104; client computing devices 103 that can access the central processing server 105 and a third party processing server 107 through a second communication network 106, which can be the same as the first communication network 104 or a separate communication network that can be the Internet, a telecommunication network, or any network supporting the TCP/IP protocol.

In accordance with various embodiments, the functionalities of the central processing server 105 comprises user authentication and user account management for managing user accounts, wherein a data record of a user account comprises the user's identification and authentication credential.

In accordance with various embodiments, the central processing server 105 includes at least one group of user interfaces for users accessible by the mobile communication devices 102 and the client computing devices 103. The group of user interfaces include interactive transactional web pages that can be displayed in web browser applications running in the mobile communication devices 102 and the client computing devices 103, and user interfaces that are specifically designed for specifically-developed mobile applications running in the mobile communication devices 102. One exemplary embodiment of such user interface is a mobile application (App) running on the iOS® operating system developed by Apple® Inc. Another exemplary embodiment of such user interface is a mobile application (App) running on the Android® operating system developed by Google® Inc. The central processing server also provides another group of user interfaces for system administrative users.

In addition to the groups of user interfaces, the central processing server 105 also includes server backend APIs for machine-to-machine integration, enabling specifically-developed software applications running in the third party processing server 107 to communicate with the central processing server 105. In accordance to various embodiments, the machine-to-machine data interchanges via the server backend APIs supports industry standards including, but are limited to, XML and JSON.

These user interfaces and server backend APIs facilitate the functionalities including, but are not limited to, user authentication, user account management, and online shopping by users, system administration by administrators, online shopping inventory, payment, and fulfillment management by users.

In accordance with various embodiments, the central processing server 105 includes a database for preserving data records of the user accounts, system configuration data, and other meta data. The database can be implemented in the same physical computer server of the central processing server 105, or in a separate physical computer server. Exemplary embodiments of the database are various commercially available relational database management systems such as Oracle® Database and Microsoft® SQL Server.

In accordance with various embodiments, each of the mobile communication devices 102 is equipped with a camera or scanner for optically capturing images of computer-generated encoded data such as barcodes. In accordance with various embodiments, the mobile communication device is configured to process the captured encoded data image and exchange data with the central processing server for facilitating various aforementioned functionalities such as user authentication. In accordance with various embodiments, the mobile communication device configuration for processing the encoded data and executing a mobile transaction is accomplished by installing and executing mobile application software and/or firmware specifically designed for the mobile communication device (hereinafter referred to as secure mobile transaction mobile application). Optionally, the operating system (OS) of the mobile communication device is modified and/or configured to accomplish portions or all of the aforementioned functionalities.

The central processing server 105 with its database, user interfaces and server backend APIs, and the mobile communication devices 102 running the secure mobile transaction mobile application constitute a secure mobile transaction system. In accordance with various embodiments, each user account in the secure mobile transaction system may associate (pair) with only a single mobile communication device 102 at any one time. Each of the users 101 may also be required to define a security personal identification number (PIN) for his/her user account according to the system configuration. A user account is created in the central processing server and its record data is stored in the database of the central process server when a new user is registered in the secure mobile transaction system. The user registration process includes steps for registering and pairing his/her mobile communication device. In accordance with various embodiments, the user registration process adopts that of the secure mobile payment system as disclosed in U.S. patent application Ser. No. 13/602,197.

In accordance with various embodiments, the computer-generated barcode is a matrix or two-dimensional barcode such as a Quick Response (QR) code. The barcode can be generated by the central processing server 105. The barcode contains at least an identity data, which is unique to each barcode at least within the secure mobile transaction system if not globally. The barcode can be electronically displayed on the screen of a client computing device 103 or mobile communication device 102. The barcode can also be printed and displayed on various portable articles including, but not limited to, a paper ticket and a carrying card.

In accordance with various embodiments, all communications between the mobile communication devices 102 and the central processing server 105 are PKI encrypted using, for example, AES, and the data communication messages are transmitted over Secure Socket Layer (SSL).

### User Authentication

In accordance to one embodiment, a user who has already been registered and created a valid user account in the secure mobile transaction system may use his/her mobile communication device that has already been registered and paired in the secure mobile transaction system to authenticate for accessing a protected third party application, such as a third party web site, provided by the third party processing server, or one or more protected user interfaces provided by the central processing server.

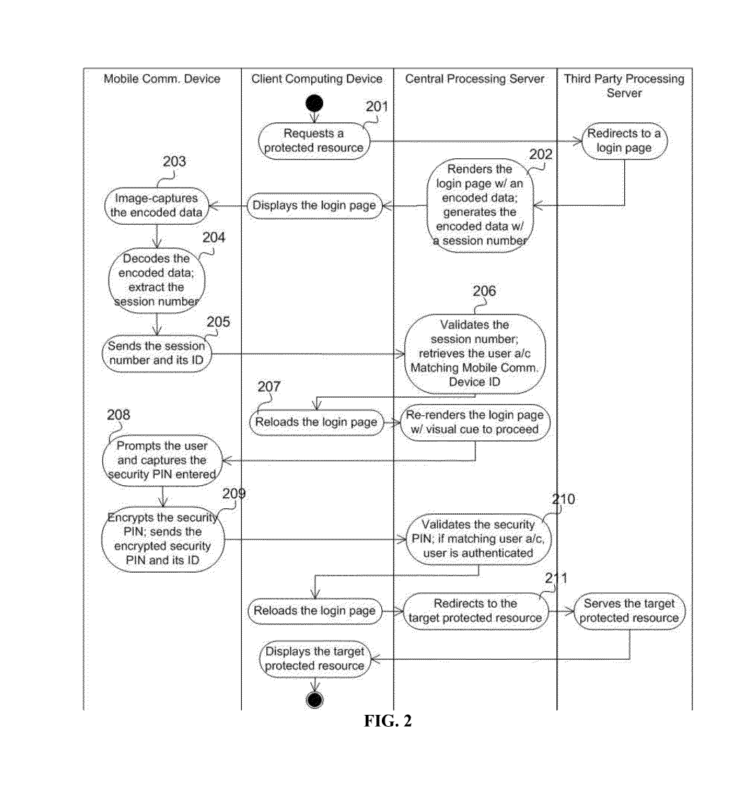

Referring to FIG. 2. The user authentication method comprises the following steps:

1. (201) A user requesting to access the protected third party application provided by the third party processing server or the one or more protected user interfaces provided by the central processing server, wherein the protected third party application can be a third party web site that is protected by access control and requires user authentication for its access and which can be accessed through a web browser application running in a first mobile communication device or a first client computing device, and wherein the protected user interfaces provided by the central processing server can be interactive transactional web pages that are protected by access control and require user authentication for their accesses and which can be accessed through a web browser application running in a first mobile communication device or a first client computing device.

2. (202) The user is redirected to a login page, wherein the login page can be served from the third party processing server or the central processing server. The login page includes an encoded data such as a barcode that is displayed on the screen of the first mobile communication device or the first client computing device. The barcode can be a QR code. The encoded data is dynamically generated by the central processing server during the rendering of the login page.

In one embodiment, the generation of the encoded data comprises the central processing server generating a random number, wherein the random number can be 32 characters (30 characters+2 checksum) in length; and encoding the random number into a QR code for the encoded data. The random number is a session number for later associating with the user's logon session. In an alternative embodiment, the generation of the encoded data comprises the central processing server encoding one of its previously generated and preserved session numbers into a QR code for the encoded data. A record of the session number is preserved in the database of the central processing server for later validation purposes.

If the login page is served by the third party processing server, the third party processing server requests and receives the encoded data from the central processing server by invoking the central processing server backend APIs.

3. (203) The login page with the encoded data is displayed on the screen of the first mobile communication device or the first client computing device. The user, using a second mobile communication device that has already been registered and paired in the secure mobile transaction system, image-captures the encoded data.

In an alternative embodiment, instead of being displayed on the screen of the first mobile communication device or the first client computing device, the encoded data can also be printed on a physical media, such as a paper ticket or a carrying card, to be presented to the user to image-capture the encoded data using the second mobile communication device.

4. (204) The second mobile communication device, running the secure mobile transaction mobile application, decodes the image-captured encoded data and extracts the session number.

5. (205) The second mobile communication device sends the extracted session number along with the identification data of the second mobile communication device to the central processing server.

6. (206) The central processing server receives the session number and the identification data of the second mobile communication device; and validates the session number by matching the previously preserved record of the session number in its database. Upon positive validation, the central processing server retrieves the user account record by matching the identification data of the second mobile communication device. The central processing server associates the session number to the user account.

7. (207) If the login page is served by the central processing server, when the web browser application displaying the login page is refreshed under auto-reload (polling) or manual reload, the login page is re-rendered by the central processing server with visual cue for the user to proceed to the next step of the user authentication.

If the login page is served by the third party processing server, the third party processing server is notified of the successful association of the session number to the user account by way of the central processing server backend API callback or response, or repeated invocations (polling) of the central processing server backend APIs by the third party processing server. Once the notification is received, when the web browser application displaying the login page is refreshed under auto-reload (polling) or manual reload, the login page is re-rendered by the third party processing server with visual cue for the user to proceed to the next step of the user authentication.

8. (208) The user enters his/her security PIN in the user interface of the secure mobile transaction mobile application running in the second mobile communication device.

9. (209) The second mobile communication device cryptographically encrypts the security PIN and sends the encrypted security PIN along with its identification data to the central processing server.

10. (210) The central processing server receives the encrypted security PIN and the identification data of the second mobile communication device; retrieves the user account record by matching the identification data of the second mobile communication device; decrypts the encrypted security PIN and validates the decrypted security PIN against the security PIN stored in the user account record. Upon a possible validation, the user is considered authenticated and the session number is now associated with the user's logon session.

11. (211) If the login page is served by the central processing server, when the web browser application displaying the login page is refreshed under auto-reload (polling) or manual reload, the web browser application is redirected to the target protected third party application or protected user interfaces provided by the central processing server.

If the login page is served by the third party processing server, the third party processing server is notified of the successful user authentication by way of the central processing server backend API callback or response, or repeated invocations (polling) of the central processing server backend APIs by the third party processing server. Once the notification is received, when the web browser application displaying the login page is refreshed under auto-reload (polling) or manual reload, the web browser application is redirected to the target protected third party application or protected user interfaces provided by the central processing server.

In another embodiment, the central processing server and the second mobile communication device, through the secure mobile transaction mobile application, are configured as such that the security PIN to be provided by the user is optional in the user authentication. Thus, the abovementioned steps 7 to 10 may be opted out, and in this case the user authentication is completed upon the positive validation of the session number and the identification data of the second mobile communication device received by the central processing server.

The embodiments disclosed herein may be implemented using general purpose or specialized computing devices, mobile communication devices, computer processors, or electronic circuitries including but not limited to digital signal processors (DSP), application specific integrated circuits (ASIC), field programmable gate arrays (FPGA), and other programmable logic devices configured or programmed according to the teachings of the present disclosure. Computer instructions or software codes running in the general purpose or specialized computing devices, mobile communication devices, computer processors, or programmable logic devices can readily be prepared by practitioners skilled in the software or electronic art based on the teachings of the present disclosure.

In some embodiments, the present invention includes computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Exemplary embodiments of mobile communication devices include, but are not limited to, mobile telephones, mobile telephones with personal computer like capability (commonly referred to as “smartphones”), electronic personal digital assistants (PDAs), portable computers with wired or wireless wide-area-network and/or telecommunication capability such as tablet personal computers and “netbook” personal computers. Examples of mobile communication devices include, but not limited to, the Apple® iPhone®, Google® Nexus™ 10, HTC® One™, Nokia® Lumia™, Samsung® Galaxy™, and Sony® Xperia™.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A computer processor implemented method for online user authentication, comprising:
generating an encoded data, by a central processing server, wherein the encoded data is encoded for a data comprising a session number stored in the central processing server;
presenting the encoded data to a user for user authentication;
image-capturing the encoded data, by a mobile communication device equipped with a camera or optical scanner, wherein the mobile communication device is associated with a user account associated with the user, wherein the user account record is stored in the central processing server, and wherein the user account record comprises an identification data of the mobile communication device;
decoding the image-captured encoded data, by the mobile communication device, to extract the session number;
sending, by the mobile communication device, the extracted session number and an identification data of the mobile communication device to the central processing server; and
authenticating the user, by the central processing, by matching the extracted session number and the identification data of the mobile communication device received from the mobile communication to the session number stored in the central processing and the identification data of the mobile communication device in the user account record.

2. The method of claim 1, wherein the encoded data is a quick response (QR) code.

3. The method of claim 1, further comprising:
capturing, by the mobile communication device, a security personal identification number (PIN) provided by the user, wherein the user account record further comprises a saved security PIN pre-defined by the user;
sending, by the mobile communication device, the security PIN to the central processing server; and
authenticating the user, by the central processing server, by matching the security PIN received from the mobile communication device with the saved security PIN pre-defined by the user in the user account record in addition to matching the extracted session number and the identification data of the mobile communication device received from the mobile communication to the session number stored in the central processing and the identification data of the mobile communication device in the user account record.

4. The method of claim 1, wherein the presentation of the encoded data to a user for user authentication is by displaying a login user interface that includes the encoded data on a screen of a client computing device.

5. The method of claim 1, wherein the presentation of the encoded data to a user for user authentication is by presenting a physical media imprinted with the encoded data.

6. A system for online authenticating a user, comprising:
a central processing server configured to:
generate an encoded data, wherein the encoded data is encoded for a data comprising a session number stored in the central processing server; and
authenticate the user by matching the extracted session number and an identification data of an mobile communication device received from the mobile communication to the session number stored in the central processing and the identification data of the mobile communication device in an user account record associated with the user;
the mobile communication device, which is equipped with a camera or optical scanner, is configured to:
image-capture the encoded data when the encoded data is presented for user authentication;
decode the image-captured encoded data to extract the session number; and
send the extracted session number and an identification data of the mobile communication device to the central processing server;
wherein the mobile communication device is associated with the user account, wherein the user account record is stored in the central processing server, and wherein the user account record comprises an identification data of the mobile communication device.

7. The system of claim 6, wherein the encoded data is a quick response (QR) code.

8. The system of claim 6, wherein:
the mobile communication device is further configured to:
capture a security personal identification number (PIN) provided by the user, wherein the user account record further comprises a saved security PIN pre-defined by the user; and
send the security PIN to the central processing server; and
the central process server is further configured to:
authenticate the user by matching the security PIN received from the mobile communication device with the saved security PIN pre-defined by the user in the user account record in addition to matching the extracted session number and the identification data of the mobile communication device received from the mobile communication to the session number stored in the central processing and the identification data of the mobile communication device in the user account record.

9. The system of claim 6, wherein the presentation of the encoded data for user authentication is by displaying a login user interface that includes the encoded data on a screen of a client computing device.

10. The system of claim 6, wherein the presentation of the encoded data for user authentication is by presenting a physical media imprinted with the encoded.
